(19) United States
(12) Patent Application Publication
(10) Pub. No.: US 2009/0271003 A1
(43) Pub. Date: Oct. 29, 2009

(54) INTEGRATED LIGHT AND FRAGRANCE SYSTEM

(75) Inventors: Benedicte Maria Elizabeth Van Houtert, Luyksgestel (NL); Stefab Marcus Vergrugh, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,826

(22) PCT Filed: Dec. 14, 2005
(86) PCT No.: PCT/IB2005/054245

§ 371 Date: Jun. 15, 2007

Related U.S. Application Data
(60) Provisional application No. 60/636,365, filed on Dec. 15, 2004.

(51) Int. Cl. G05B 11/01; G06F 15/18; G06N 7/04; G06N 5/02

(52) U.S. Cl. 700/8; 700/90; 706/47; 706/16

(57) ABSTRACT

An integrated light and fragrance system automatically controls (150) aromatic effects (125) based on a user's control (111) of lighting effects (115). The system accepts one or more sets of lighting-fragrance correlations (165) from which to determine a preferred aromatic effect (161, 162) from a selected lighting effect (151, 152). Optionally, these sets of lighting-fragrance correlations (165) are provided by third-party vendors (310) who employ the skills of expert ambiance designers. In an alternative embodiment, the system may also use these sets of lighting-fragrance correlations (165) to control lighting effects (115) based on a user's control (121) of the fragrance effects (125). In each of these embodiments, the user merely controls (111, 121) a desired first effect (115, 125), and a suitable second effect (125, 115) is created to enhance the first effect (115, 125).

This invention relates to the field of lighting systems, and in particular to a lighting system that is integrated with a fragrance-dispersal or aroma-diffuser system.

The lighting of an environment has a significant effect on the ambiance associated with the environment. Environments conducive to reading are typically brightly lit; environments conducive to romance are typically dimly lit; and so on. In addition to the luminance level, the chromatic content also affects the ambiance of the environment. A yellow or red tinted light is generally considered to be “warmer” than a blue tinted light. Similarly, the saturation (white content) of the light and other parameters, such as the degree of dispersion of the light, will affect the ambiance.

U.S. Published Patent Application 2003/0057887, “SYSTEMS AND METHODS OF CONTROLLING LIGHT SYSTEMS”, filed 13 Jun. 2002, discloses a multi-light system wherein the color and intensity of each light, or sets of lights, is controlled from a central controller via wireless communications, and is incorporated by reference herein. A graphic representation of the environment being controlled is preferably used to select and assign control parameters for each light or set of lights. These parameters are stored in a file, and “played back” (i.e. read from the file and communicated to the lights) when desired. The playback may be initiated directly by a user, or programmed to occur according to a defined schedule.

In like manner, aroma can have a significant effect on the ambiance associated with the environment. Scents such as eucalyptus and peppermint typically convey an active or invigorating ambiance, whereas chamomile and sage convey a more relaxing atmosphere.

Generally, the choice of lighting and aroma are coordinated to provide a coherent ambiance to induce a desired effect. The Kurhaus Hotel in the Netherlands, for example, provides a “Result Room”, wherein the lighting and aroma of a meeting room are adjusted to present an environment conducive to a particular meeting objective. For example, if a negotiating meeting is planned, the room's color is set to blue, and an aromatic mix of chamomile, lavender, and sage is diffused through the room; if a decision-making meeting is planned, the room's color is set to red, and an aromatic mix of lemon, rosemary, and cedar is provided; if an idea-forming meeting is planned, the room's color is set to yellow, and an aromatic mix of bergamot, orange, and rosewood is provided. Other combinations of colors and aromas, including user-defined lighting and aromatic effects, are also available.

PCT patent application PCT/US03/14769, “COORDINATED EMISSION OF FRAGRANCE, LIGHT, AND SOUND”, filed 13 May 2003 and published as WO 03/098971 on 27 Nov. 2003, discloses a computer system that is configured to allow the coordinated programming of particular light, fragrance, and sound effects. The programming may be included with the computer, or provided by the user. The user selects a time to execute one or more of the programmed combinations of light, fragrance, and sound effects.

To achieve a desired ambiance, the user must either select from a set of predefined effects, or must define a particular combination of lighting and aromatic effects. In many situations, such as when the user merely enters his or her living room, the user may not be consciously aware of desiring a particular effect, or may not be interested in initiating the task of choosing from a menu of ambiance effects, and thus working to achieve a pleasurable combination of lighting and aroma is not a task that the user will actively pursue. In other situations, the user may attempt to create a desired effect, but lacking the skills of an ambiance-designer, may create a highly discordant combination of light and aroma effects. In other situations, the user may select a predefined ambiance, and after awhile realize that the effect is not exactly what he or she intended, but the task of reprogramming the system and/or selecting from a menu of predefined effects is not inviting. Similarly, the predefined effects may not be suitable for the particular user. For example, if the user chooses a “romantic” effect, the lighting may be too dim, or too bright, for the particular user's environment. Although, in most systems, the user is able to override the programmed controls in such a situation, once the user introduces such a change, the advantage of using a presumably expertly-designed predefined effect is diminished.

It is an object of this invention to provide an integrated light and fragrance system that provides an easy-to-use user interface. It is a further object of this invention to provide an integrated light and fragrance system that provides expert-based coordination of light and fragrance effects through a range of user controls. It is a further object of this invention to provide an integrated light and fragrance system that encourages the development of expert-based ambiance effects.

These objects and others are achieved by an integrated light and fragrance system that automatically controls the aromatic effects based on a user's control of the lighting effects. The system accepts one or more sets of lighting-fragrance correlations from which to determine a preferred aromatic effect from a selected lighting effect. Optionally, these sets of lighting-fragrance correlations are provided by third-party vendors who employ the skills of expert ambiance designers. In an alternative embodiment, the system may also use these sets of lighting-fragrance correlations to control lighting effects based on a user's control of the fragrance effects. In each of these embodiments, the user merely controls a desired first effect, and a suitable second effect is created to enhance the first effect.

The invention is explained in further detail, and by way of example, with reference to the accompanying drawings wherein:

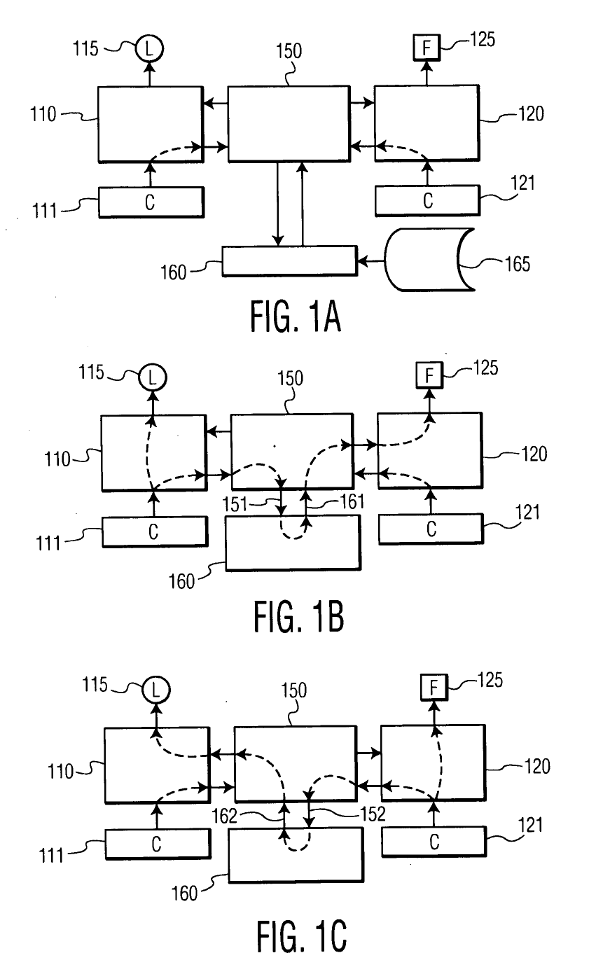

FIGS. 1A-1C illustrate example block and flow diagrams of an integrated light and fragrance system in accordance with this invention.

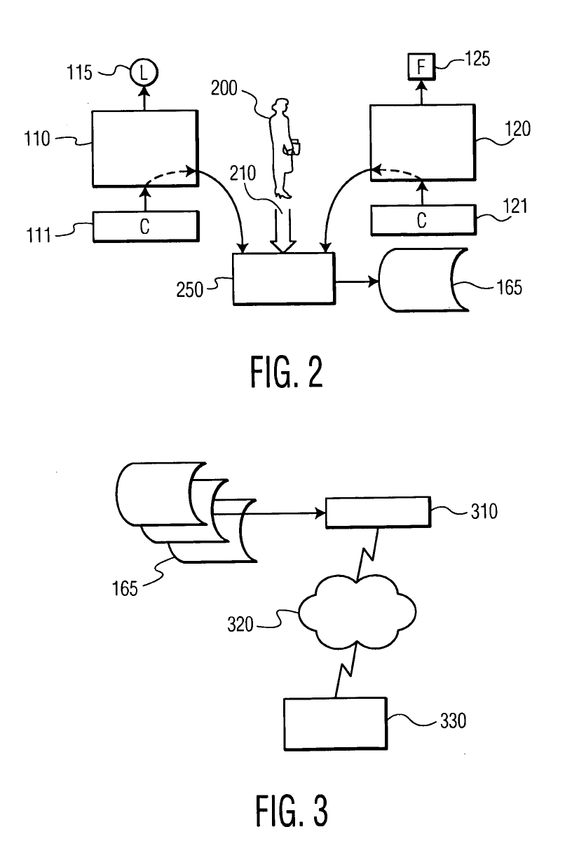

FIG. 2 illustrates an example block diagram of a system for creating correlation data for use in an integrated light and fragrance system in accordance with this invention.

FIG. 3 illustrates an example block diagram of a system for providing correlation data for use in an integrated light and fragrance system in accordance with this invention.

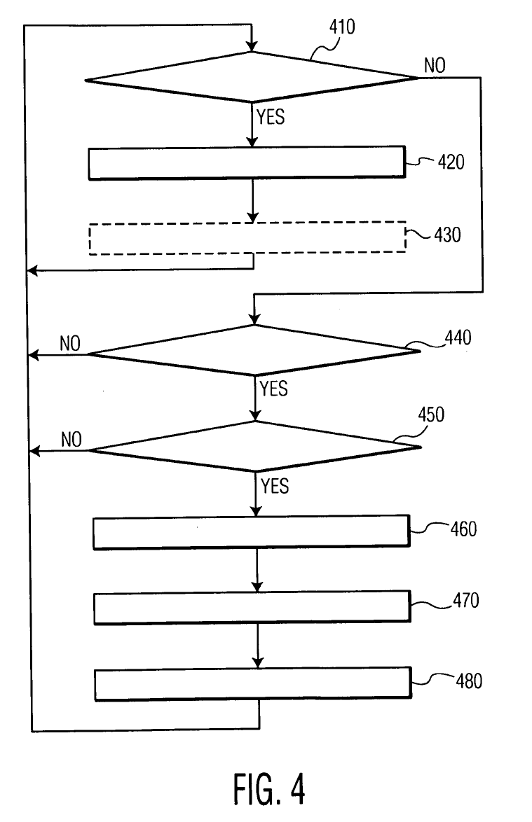

FIG. 4 illustrates an example flow diagram of an integrated light and fragrance system in accordance with this invention.

Throughout the drawings, the same reference numeral refers to the same element, or an element that performs substantially the same function. The drawings are included for illustrative purposes and are not intended to limit the scope of the invention.

FIG. 1A illustrates an example block diagram of an integrated light and fragrance system in accordance with this invention. This example embodiment includes a lighting system 110, a fragrance system 120, and a controller 150 that coordinates the control of these systems 110, 120.

The lighting system 110 includes a control device 111 that is configured to control one or more lights 115. In a preferred embodiment of this invention, the control device 111 provides for the control of the intensity/luminance of the lights 115, as well as other ambiance-affecting characteristics of the lights 115, such as color/chrominance, purity, saturation, and so on, via control of the lighting system 110. Copending U.S. patent application “MULTI-DIMENSIONAL CONTROL OF LIGHTING PARAMETERS”, Ser. No. ______, filed ______ for Elmo Diederiks, Martijn Santbergen, and Gerard Hollemans, Attorney Docket ______ (ID 697711), and incorporated by reference herein, teaches a multi-dimensional control device, such as a three-dimensional track-ball, that is configured to allow a user to easily control multiple lighting parameters, and is particularly well-suited for use in an embodiment of this invention.

The fragrance system 120 similarly includes a control device 121 that is configured to control one or more fragrance dispensers 125. In a preferred embodiment of this invention, the control device 121 controls the intensity of the fragrance, as well as the particular scent, lingering characteristics, and so on.

The controller 150 is configured to integrate and simplify the operation of the lighting 110 and fragrance 120 systems by controlling one of the systems 110, 120 based on the user's control of the other system 120, 110. In this manner, for example, a user need only adjust the lighting system 110 for a desired ambiance, and a coordinated fragrance is automatically provided to reinforce the desired effect. In a preferred embodiment of this invention, to avoid the dispensing of multiple scents, the control of the fragrance system 120 is applied after it is determined that the changes to the lighting system are not on-going.

A correlation device 160 is configured to facilitate the determination of coordinated lighting and fragrance effects, preferably based on correlations 165 developed by experts in the field of interior/environmental design. For example, dim or average light with blue hues may be correlated with a mix of chamomile, lavender, and sage, wherein the intensity of the scent is inversely proportional to the intensity of the light, and/or the saturation level, the mix of lavender increasing as the blue hue tends to violet, and so on. In like manner, dim light with red hues may be correlated with a light rose scent, and a bright white light may be correlated with a very light scent of pine, or with no scent at all. A basic set of correlations may be provided by the manufacturer of the integrated lighting and fragrance system, and additional correlations made available from third party vendors, as discussed further below.

Preferably, the controller 150 is configured to be compatible with a variety of lighting systems 110 and fragrance systems 120, and is configured to transform the information from the correlation device 160 regarding lighting and fragrance characteristics into control parameters for the particular systems 110, 120 to achieve the desired effects. Alternatively, if the systems 110, 120 and controller 150 are integrated as a single control system, the correlation device 160 can be configured to receive as input the actual control parameter used to control one of the systems 110, 120, and to provide as output the actual control parameter used to control the other system 120, 110. These and other techniques for structuring the interactions among the systems and devices 110-160 will be evident to one of ordinary skill in the art in view of this disclosure.

FIG. 1B illustrates an example flow diagram of the use of the integrated lighting and fragrance system. Using control device 111, a user adjusts the characteristics of the lights 115, via the lighting system 110. The controller 150 detects this change of lighting characteristics, preferably by monitoring the operation of the lighting system 110 or the control device 111 directly. If a direct monitoring of the system 110 or device 111 is not used, the controller 150 can be configured to detect the effects of the applied control, using for example, light and color sensors in the area that is affected by the lights 115, or via a camera that provides an image of the affected area to the controller 150.

Based on the change of lighting characteristics, the controller 150 provides information 151 corresponding to the determined lighting control to the correlation device 160, and receives information 161 from the correlation device 160 corresponding to a preferred fragrance corresponding to this lighting control. Based on the information corresponding to the preferred fragrance, the controller 150 applies control to the fragrance system 120 to effect the dispersion of the preferred fragrance, via the fragrance dispensers 125.

The flow of FIG. 1B corresponds to the expected typical use of the system, because it is assumed that most users will be comfortable adjusting the lighting effects in an environment, and allowing the system to automatically determine a coordinated fragrance. However, in an optional embodiment of this invention, the system is configured to also allow a user to adjust the fragrance effects in the environment, and to automatically adjust the lighting characteristics to correspond to the selected fragrance, as illustrated in FIG. 1C.

In FIG. 1C, a user controls the fragrance system 120 via the control device 121. The controller 150 detects the change of fragrance control, and provides information 152 corresponding to the selected fragrance to the correlation device 160. In this alternative embodiment, the correlation device 160 provides information 162 regarding lighting characteristics that correspond to the selected fragrance. The controller 150 receives this information and controls the lighting system 110 to provide the desired lighting effects at the lights 115.

As noted above, the correlation device 160 preferably determines corresponding lighting and fragrance characteristics based on correlations determined by experts in the field of interior/environmental design.

FIG. 2 illustrates an example block diagram of a system for creating correlation data for use in an integrated light and fragrance system in accordance with this invention. In FIG. 2, one or more experts 200 provide feedback 210 to a training engine regarding combinations of lighting and fragrance effects produced by various combinations of control input 111, 121 to the lighting 110 and fragrance 120 systems.

Any of a variety of techniques common in the art can be used to provide a set of correlation data 165 based on the feedback 210. In a straightforward embodiment of this invention, the correlation device 160 of FIG. 1A includes a neural network or other trainable structures, and the training engine 250 includes a copy of the correlation device 160 that is set to a training mode. As each control 111, 121 is set, the expert 200 provides a correlation score 210 based on the suitability of the light and fragrance combination produced by the lights 115 and dispensers 125. In the training mode, the neural network within the training engine 250 provides a determined correlation between the controls 111, 121, based on a set of node weights within the network. In a perfectly trained system, the neural network's determined correlation would match the expert's determined correlation score 210. In the training mode, when a difference exists, the correlation score 210 is used to adjust the node weights to provide a determined correlation that is closer to the correlation score 210. When the training is completed, the resultant node weights are stored as the expert correlation data 165.

When the correlation data 165 is provided to the correlation device 160 of FIG. 1A, the node weights in the correlation data 165 are loaded into the neural network within the correlation device 160. In this manner, in a perfectly trained system, the correlation device 160 at a user's system will provide the same measure of correlation between given lighting and fragrance effects as the expert 200 of FIG. 2. In an example embodiment, the controller 150 of FIG. 1A pre-loads the correlation device 160 with a list of the available fragrances from the fragrance system 120. Thereafter, when the user adjusts the lighting system 110, the controller 150 provides the information related to the selected lighting effect to the correlation device 160, and the correlation device 160 evaluates each of the available fragrances for correlation with the selected lighting effect, and identifies the available fragrance that provided the highest correlation score to the controller 150.

In an alternative embodiment, the correlation device 160 may be a rule-based system, and the correlation data 165 is a combination of rules developed by one or more experts. In such an embodiment, the training engine 250 of FIG. 2 may include a rules generator that transforms user feedback 210 into a set of rules that form the expert data 165. Alternatively, the feedback 210 may be an explicit set of rules, and the training engine 250 is merely an interface that facilitates the input of explicit rules. For example, an expert 200 may explicit state: “If the hue is red, the fragrance should include a rose scent”, or “If the lighting level is high, the scent intensity should be low”, or “If the lighting level is low, do not use orange scent”, and so on. In a rules-generating embodiment, the training engine 250 deduces a set of rules based on the expert's feedback 210. For example, if the expert 200 seems to consistently prefer rose scent when red hues are present, the training engine 250 may deduce the above “If the hue is red, the fragrance should include a rose scent” rule. In a typical rules-based system, a weight may also be applied to each rule, or each group of rules, to set the rule's importance, ranging, for example from an ‘absolute rule’ to a ‘suggestion’.

In this alternative embodiment, the correlation device 160 is configured to apply the expert-developed rules 165, and to choose an available scent based on how well each scent matches the given rules, weighted by the importance of each rule.

In a simpler alternative embodiment, the expert data 165 may merely be a matrix, or a set of matrices, that maps lighting effects to fragrance effects, and the training engine 250 provides an interface for creating these matrices. If the matrix provides an ordering of lighting and fragrance effects, interpolation techniques can be used to determine the preferred effects for control settings that are not explicitly included in the matrix.

As techniques for defining fragrances are further developed, an algorithmic technique may be used to calculate a fragrance based on a given lighting effect, and vice versa. For example, light can be mapped to a multi-dimensional color space, such as an RGB (red-green-blue) color space, or HSI (hue, saturation, intensity) color space. If a mapping of fragrance to a multi-dimensional aroma space is defined, the correlation device 160 may include a processor that transforms a coordinate in a color space to a corresponding coordinate in an aroma space. In such an embodiment, different experts may provide different transform equations to achieve different effects, and/or the transforms may include user definable parameters that provide a personal-touch to the algorithmically defined combinations.

These and other techniques for creating correlation data 165 that maps lighting characteristics to fragrance characteristics, and optionally, fragrance characteristics to lighting characteristics, will be evident to one of ordinary skill in the art in view of this disclosure.

FIG. 3 illustrates an example block diagram of a system for providing correlation data 165 for use in an integrated light and fragrance system in accordance with this invention. A network 320, such as the Internet, links a user's system 330 with a server 310 that provides access to one or more sets of correlation data 165, which are preferably developed by experts in the field of interior/environmental design. The server 310 may be provided by a vendor of the integrated light and fragrance system of this invention, or by another party. Supplying the correlation data 165 may be a commercial venture, wherein the user pays a fee for each copy, or the correlation data 165 may be freely provided to encourage purchase of the integrated light and fragrance system, or other products, such as particular lighting devices, fragrance dispensers, or fragrances for use in the system.

FIG. 4 illustrates an example flow diagram of an integrated light and fragrance system in accordance with this invention. The system is illustrated as continuously looping, although one or ordinary skill in the art will recognize that an interrupt-driven embodiment may also be used.

At 410, a first control is checked to see if a change has occurred. If so, an alarm is set, at 420, and a timer that is associated with the alarm is reset. Not illustrated, if the system provides either light or fragrance control based on control of the other, different alarms and timers could be used for each detected control change. If the integrated system is configured to be the sole controller of the lighting and fragrance systems, the system effects the control of the corresponding system based on the detected control change, at 430. If, on the other hand, the systems 110, 120 of FIG. 1A automatically control the associated devices 115, 125 based on the input from the control devices 111, 121, then block 430 can be omitted. The system loops back to 410 to continue to monitor for control changes.

If, at 410, a control change is not detected, the system determines whether an alarm is pending, at 440. If not, the system loops back to 410. If an alarm is pending, the system determines whether a predefined time duration has expired since the timer was reset, at 450. If not, the system loops back to 410. This looping for the predefined time duration assures that the second system is not automatically controlled while the first system is still being adjusted by the user. This predefined delay is typically set to be different for each of the systems 110, 120, because prematurely adjusting the lights is likely to be less consequential than prematurely dispersing a scent, due to the different persistence of each effect.

If, at 450, the predefined delay has occurred since the timer was last reset, the coordinated control for the second system, based on the detected change of control of the first system is determined, at 460, and applied to the second system, at 470. At 480, the alarm is cleared, and the system loops back to 410 to continue to monitor for control changes.

Although not explicitly illustrated in the figures, in a preferred embodiment, the automated control 150 can be disabled by the user, and the correlation data 165 can be modified by the user. Similarly, each of the parameters of the system, such as the delay times before activating the control of the lighting or fragrance system are configured to be adjustable by the user.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the correlation device 160 can be configured to apply different correlation data 165 based on other parameters, such as the time of day, day of the week, an identification of the particular user, and so on. These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements.

1. A system that includes:
a first subsystem (110, 120) that provides a first ambiance effect (115, 125) based on a first control (111, 121),
a second subsystem (110, 120) that provides a second ambiance effect (115, 125) based on a second control (161, 162), and
a controller (150) that is configured to allow a user to set the first control (111, 121) and to determine therefrom the second control (161, 162), based on a predefined correlation (165) between the first ambiance effect (115, 125) and the second ambiance effect (115, 125).

2. The system of claim 1, wherein
the first subsystem (110, 120) is a lighting system (110), and
the second subsystem (110, 120) is a fragrance system (120).

3. The system of claim 1, wherein
the first subsystem (110, 120) is a fragrance system (120), and
the second subsystem (110, 120) is a lighting system (110).

4. The system of claim 1, further including
a device (360) that is configured to receive the predefined correlation (165) from a source (310) that is external to the system.

5. The system of claim 1, further including
a correlation device (160), operably coupled to the controller (150), that is configured to:
receive an input (151, 152) from the controller (150) corresponding to the first control (111, 121), and
provide an output (161, 162) to the controller (150) corresponding to the second control.

6. The system of claim 5, wherein
the correlation device (160) includes at least one of:
a rule-based engine,
a neural network, and
a correlation matrix.

7. The system of claim 6, further including
a training module (250) that is configured to program the correlation device (160) based on empirical ambiance trials.

8. The system of claim 1, further including
a multi-dimensional user control (111, 121) that is configured to allow the user to set the first control (111, 121).

9. A method of controlling an ambiance system (110, 120), comprising:
determining a control (111, 121) of an other ambiance system (110, 120),
determining a corresponding control (161, 162) for the ambiance system (110, 120), based on a correlation (165) between the control (111, 121) of the other ambiance system (110, 120) and the corresponding control (161, 162) of the ambiance system (110, 120), and
applying the corresponding control (161, 162) to the ambiance system (110, 120).

10. The method of claim 9, wherein
determining the control (111) of the other ambiance system (110) includes determining lighting parameters, and
applying the corresponding control (161) includes applying fragrance parameters.

11. The method of claim 9, wherein
determining the control (121) of the other ambiance system (120) includes determining fragrance parameters, and
applying the corresponding control (162) includes applying lighting parameters.

12. The method of claim 9, further including
receiving the correlation (165) from an external source (310).

13. The method of claim 9, further including
determining the correlation (165).

14. The method of claim 9, wherein
determining the corresponding control (161, 162) for the ambiance system (110, 120) includes:
applying parameters corresponding to the control (111, 121) of the other ambiance system (110, 120) to a correlation device (160) and
receiving an output from the correlation device (160) corresponding to the corresponding control (161, 162) for the ambiance system (110, 120).

15. The method of claim 14, further including
training (250) the correlation device (160) based on empirical ambiance tests.

16. A method of facilitating control of a multiple ambiance system, comprising:
receiving a request for correlation data (165) that associates control of a first ambiance subsystem (110, 120) to control of a second ambiance subsystem (110, 120),
providing the correlation data (165) in a form that is compatible with a control system (150) that is configured to control the second ambiance subsystem (110, 120) based on a user's control of the first ambiance subsystem (110, 120).

17. The method of claim 16, wherein
the correlation data (165) associates control of a lighting subsystem (110) with control of a fragrance subsystem (120).

18. The method of claim 16, wherein
the correlation data (165) corresponds to at least one of:
a set of rules,
a set of neural network node weights, and
a matrix of values.

19. The method of claim 16, wherein
providing the correlation data (165) includes transmitting the correlation data (165) via an Internet connection (320).

20. A server (310) comprising:
a receiver that is configured to receive a request for correlation data (165) that associates control of a first ambiance system (110, 120) with control of a second ambiance system (110, 120),
a transmitter that is configured to provide the correlation data (165) in a form that is compatible with a control system that is configured to control the second ambiance system (110, 120) based on a user's control of the first ambiance system (110, 120).

21. The server of claim 20, wherein
the correlation data (165) associates control of a lighting system (110) with control of a fragrance system (120).

22. The server of claim 20, wherein
the correlation data (165) corresponds to at least one of:
a set of rules,
a set of neural network node weights, and
a matrix of values.

23. The server of claim 20, wherein
the receiver and transmitter are configured to receive and transmit the correlation data (165) via an Internet connection (320).

24. A control system for controlling an ambiance system (110, 120), comprising:
a controller (150) that is configured to determine a control (111, 121) of an other ambiance system (110, 120), and
a correlation device (160), operably coupled to the controller (150), that is configured to receive information (151, 152) from the controller (150) corresponding to the control of the other ambiance system (110, 120), and to determine therefrom corresponding information (161, 162) related to control of the ambiance system (110, 120),
wherein
the controller (150) is further configured to apply corresponding control to the ambiance system (110, 120), based on the corresponding information (161, 162) from the correlation device (160).

25. The control system of claim 24, wherein
the correlation device (160) determines the corresponding information (161, 162) based on a correlation (165) between effects produced by the control of the other ambiance system (110, 120) and effects produced by the corresponding control of the ambiance system (110, 120).

26. The control system of claim 25, wherein
the correlation (165) corresponds to correlation (165) between lighting effects and fragrance effects.

27. The control system of claim 25, wherein
the correlation device (160) is configured to receive the correlation (165) from an external source.

28. The control system of claim 24, wherein
the correlation device (160) corresponds to a trainable device (250).
